(19) United States
(12) Patent Application Publication
(10) Pub. No.: US 2009/0104823 A1
(43) Pub. Date: Apr. 23, 2009

(54) PRESS-IN PIN

(76) Inventor: Ronny Ludwig, Reutlingen (DE)

Correspondence Address: KENYON & KENYON LLP, ONE BROADWAY, NEW YORK, NY, 10004, US

(21) Appl. No.: 12/300,739

(22) PCT Filed: Jul. 13, 2007
(86) PCT No.: PCT/EP2007/057245

§ 371 Date: Nov. 13, 2008

(30) Foreign Application Priority Data
Aug. 30, 2006 (DE) 10 2006 040 640.0

(51) Int. Cl. H01R 11/22

(52) U.S. Cl. 439/857

(57) ABSTRACT

A press-in pin for producing an electrical connection to a receptacle receiving a section of the press-in pin, having an elastic press-in zone which produces the electrical connection. It is provided that the press-in zone forms a first press-in zone, which is axially adjoined by a second press-in zone, the first press-in zone and the second press-in zone having different elastic behaviors.

### FIELD OF THE INVENTION

The present invention relates to a press-in pin for producing an electrical connection to a receptacle receiving a section of the press-in pin, having an elastic press-in zone which produces the electrical connection.

### BACKGROUND INFORMATION

Press-in pins of the above-mentioned type are known from the related art. In its basic function, a press-in pin produces a solderless electrical connection, for example, between a printed circuit board and a plug-in contact. The press-in zone of the press-in pin is used here, on the one hand, as an electrical contact zone and, on the other hand, as a mechanical fastening of the press-in pin on the printed circuit board. The mechanical stability of this connection is described, first and foremost, by the folding force (hole internal surface force) of the press-in zone used.

To ensure a high degree of mechanical stability, the folding force must be appropriately high. Due to technical limitations, an excessively high folding force of the press-in zone on the press-in pin results in permanent damage of a metal-plated borehole in the printed circuit board. This effect is enhanced when the number of press-in pins is increased due to the increasing spread to each other of the locations or positions of the individual press-in pins. Therefore, the selected folding force of the press-in zone always represents a compromise between mechanical stability and quality, with reference to the known defect patterns.

### SUMMARY OF THE INVENTION

It is provided according to the exemplary embodiments and/or the exemplary methods of the present invention that the press-in zone forms a first press-in zone, which is axially adjoined by a second press-in zone, the first press-in zone and the second press-in zone having different elastic behaviors. Thus, the elastic behavior of the first press-in zone is advantageously designed for optimum electrical contacting, and the elastic behavior of the second press-in zone is designed for optimum stability. The first press-in zone thus acts mainly as an electrical contact zone via which the electrical contact from the press-in zone, i.e., from the electrical/electronic component belonging to the press-in pin, to the printed circuit board is produced. The receptacle is advantageously designed as a through contact and has a metal plating. Due to the advantageous design of the press-in pin, additional safety measures or fastening measures, such as clamping the printed circuit board between a housing and a housing cover having elastic elements, are not necessary. In addition, the press-in pin according to the present invention is manufacturable cost-effectively in particular.

The first press-in zone and the second press-in zone advantageously each have a diagonal perpendicular to the axial extension of the press-in pin, which is larger than that of the receptacle, the diagonal of the second press-in zone being advantageously at least as large as the diagonal of the first press-in zone, so that when the press-in pin is pressed in, both press-in zones contact the receptacle.

To enable the press-in pin to be inserted into/through the receptacle, the press-in pin has an intrinsic elasticity, the second press-in zone advantageously having a greater elastic deformation area than the first press-in zone. The second press-in zone may thus be elastically pressed together when introduced into the receptacle, and may stress-relieve again when extracted from the receptacle and revert to its original shape because of its intrinsic elasticity. The second press-in zone thus acts, when extracted from the receptacle, as an engagement device, so that the press-in pin may not spontaneously be detached from the receptacle of the printed circuit board.

At least one opening is advantageously formed in the second press-in zone of the press-in pin, so that the press-in pin may be elastically deformed more easily and, mainly, to a greater degree, in the area of the second press-in zone. The folding force (hole internal surface force), i.e., the force needed for pressing the press-in pin together, of the second press-in zone is thus reduced. This has the advantage that during the insertion fewer transverse forces, which might damage the receptacle, i.e., the printed circuit board, act on the receptacle, and when it is extracted from the receptacle, the second press-in zone spontaneously elastically reverts to its original shape.

The first press-in zone advantageously has a larger diagonal than the receptacle, so that the first press-in zone is pre-stressed in the receptacle and ensures a reliable electrical contact between the press-in pin and the receptacle. For this purpose, the first press-in zone advantageously has an outer contour which essentially corresponds to that of the receptacle, so that the largest possible contact surface is obtained. Due to the fact that the diagonal of the first press-in zone is larger than that of the receptacle, the first press-in zone is pressed into the receptacle.

The first press-in zone is advantageously plastically deformed in the receptacle, at least partially. The first press-in zone thus has a higher folding force and ensures a “clean” electrical connection. Due to the combination of the two press-in zones having different folding forces and elastic deformation areas, a stable and reliable connection is ensured, which is thus suitable for applications such as, for example, automotive applications in which strong vibrations and/or impacts are expected.

According to a refinement of the exemplary embodiments and/or the exemplary methods of the present invention, the first press-in zone has an advantageously axial depression, which allows an at least partial plastic deformation of the press-in pin at the first press-in zone. The entire press-in pin according to the present invention may be shaped as a known press-in pin from the related art by a punch-bending tool, so that no additional manufacturing costs are generated and the press-in pin according to the present invention may be manufactured almost cost-neutrally compared to one from the related art.

The second press-in zone advantageously has a larger diagonal than the first press-in zone. this reinforces the buttonhole effect and ensures that the press-in pin is reliably secured in the receptacle. Since the second press-in zone has a larger elastic deformation area and, due to the opening, a lower folding force, the press-in pin may be pressed into the receptacle without any problem without damage to the receptacle and/or the press-in pin, the force needed for pressing in remaining approximately the same compared to the related art.

The second press-in zone advantageously has an essentially drop-like contour, its blunt end transitioning into the first press-in zone. This makes the press-in pin easy to insert and, as soon as the second press-in zone elastically reverts to its original shape, difficult to extract again.

The following drawings show the present invention on the basis of five exemplary embodiments.

### BRIEF DESCRIPTION OF THE DRAWINGS

FIG. 1 shows a top view onto a press-in pin according to the present invention.

FIG. 2 shows a cross section through the second press-in zone.

FIG. 3 shows a cross section through the first press-in zone.

FIG. 4 shows the press-in pin having a contact surface.

FIG. 5 shows the press-in pin in a receptacle.

FIG. 6 shows a folding force/folding path diagram of the press-in pin.

### DETAILED DESCRIPTION

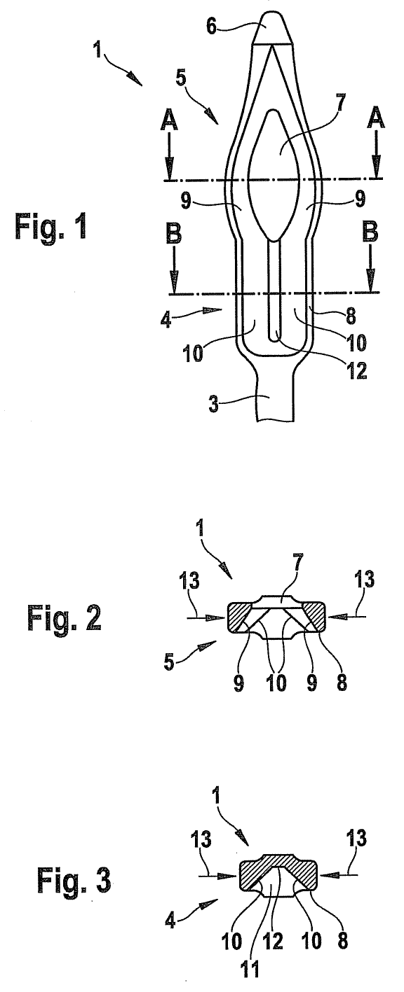

FIG. 1 shows a top view of an exemplary embodiment of a press-in pin 1 according to the present invention. Press-in pin 1 has a neck 3 coming from an electrical/electronic component, the neck transitioning into a first press-in zone 4, press-in zone 4 being wider than neck 3. Press-in zone 4 has an essentially rectangular shape. A second press-in zone 5, which has a drop-like contour, axially adjoins first press-in zone 4, a diagonal of press-in zone 5, i.e., a width of press-in zone 5, being larger perpendicularly to the longitudinal extension of press-in pin 1 than a diagonal, i.e., a width of press-in zone 4. Second press-in zone 5 transitions into a tip 6 at its end opposite to press-in zone 4.

Second press-in zone 5 has an opening 7, which has an essentially drop-shaped contour, which essentially corresponds to the outer contour of second press-in zone 5. Press-in pin 1 has an edge zone 8, which encloses first press-in zone 4 and second press-in zone 5, and transitions into neck 3 and tip 6, respectively.

As depicted in the cross-section illustrations of FIGS. 2 and 3, bevels 9 and 10 are formed in press-in zones 4 and 5, respectively, which lead from edge zone 8 into the central zone of press-in pin 1. FIG. 2 shows a section through press-in pin 1 along line A-A in press-in zone 5. Bevels 9 lead from a front side of press-in pin 1, i.e., from edge zone 8 to opening 7. In this illustration, it is also apparent that press-in pin 1 has an approximately rectangular outer contour perpendicularly to its longitudinal extension. In the viewing direction of the cross section depicted in FIG. 2, bevels 10 of first press-in zone 4 are also to be seen, which have a less steep design. FIG. 3 shows the cross section through first press-in zone 4 along a line B-B from FIG. 1. In the area of press-in zone 4, bevels 10 form a funnel-type depression 11 having a bottom surface 12, which is also referred to as a base.

Due to the geometric configuration of the two press-in zones 4 and 5, they have different behaviors. Due to opening 7 and steep bevels 9, second press-in zone 5 has a large elastic deformation area. This means that in the area of press-in zone 5, press-in pin 1 may be highly elastically deformed without problems, being compressed perpendicularly to its longitudinal extension in the direction of arrows 13, as depicted in FIG. 2. In contrast, first press-in zone 4 has a smaller elastic deformation area, so that it is plastically deformed earlier than second press-in zone 5 when forces act in the direction of arrows 13.

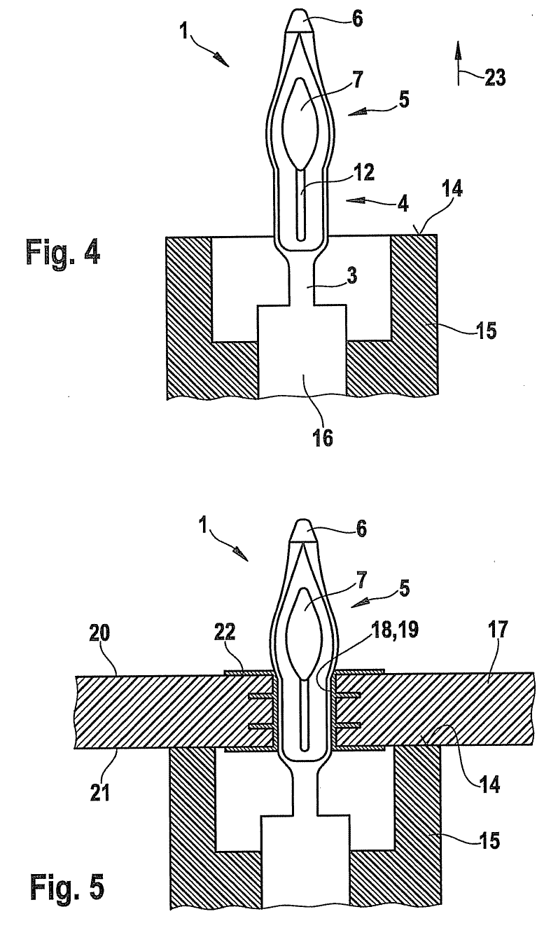

FIG. 4 shows press-in pin 2 from the previous figures in an exemplary embodiment having a contact surface 14. Press-in pin 1 is situated in a housing 15, which belongs, for example, to a housing of an electrical/electronic component, in such a way that press-in zones 4 and 5 of press-in pin 1 are essentially outside housing 15. At its end opposite to first press-in zone 4, neck 3 of press-in pin 1 transitions into a holding area 16, which is in contact with housing 15. Contact surface 14 is perpendicular to the longitudinal extension of press-in pin 1. The housing is advantageously made of plastic.

FIG. 5 shows press-in pin 1 from FIG. 4 having contact surface 14 in the assembled state on a printed circuit board 17. Printed circuit board 17 has an opening 18 as a receptacle, which is designed as a through contact 19. For this purpose, opening 18 and an area near opening 18 on top 21 and bottom 22 of printed circuit board 17 have a metal plating 22. If press-in pin 1 is introduced into opening 18 of printed circuit board 17 in the direction of arrow 23 depicted in FIG. 4, tip 16 initially centers press-in pin 1 in opening 18. When pushed further, press-in zone 5 of press-in pin 1 is compressed because the diagonal of press-in zone 5 is larger than opening 18. Due to the configuration of press-in zone 5, press-in pin 1 is elastically deformed in the area of press-in zone 5, so that when press-in zone 5 is extracted from opening 18, it elastically reverts to its original shape.

Due to the fact that press-in zone 5 is wider than opening 18 and has a drop-like shape, the so-called buttonhole effect is obtained, so that press-in pin 1 cannot easily be extracted from opening 18 of printed circuit board 17 (in the direction opposite to arrow 23) and is positively held on printed circuit board 17. Since press-in pin 1 is only elastically deformed in the area of press-in zone 5, it has a low folding force in this area, the folding force being the force needed to deform press-in zone 5. This has the advantage that, when the press-in pin is inserted, only weak transverse forces, which cause no damage, act on metal plating 22 of opening 18. Due to its geometric configuration, press-in zone 4 has a higher folding force than press-in zone 5 and a smaller elastic deformation area. Since it advantageously also has a diagonal which is larger than that of the receptacle, i.e., opening 18, it is deformed from its elastic area to the plastic deformation area and thus ensures a reliable electrical connection of press-in pin 1 to metal plating 22, i.e., printed circuit board 17. Press-in zones 4 and 5 thus together ensure a reliable electrical connection and a stable hold of press-in pin 1 on printed circuit board 17. Due to the advantageous drop-shaped contour of press-in zone 5, a lower force is needed in the direction of arrow 23 for insertion than for extraction. Contact surface 14 of housing 15 prevents press-in pin 1 from “slipping through” printed circuit board 17. Contact surface 14 is advantageously situated in such a way that press-in pin 1 is held under pre-stress in opening 18. Cost-intensive special measures are not needed due to the stable mechanical connection. In addition, the mechanical connection thus implemented is suitable for applications in which strong vibrations and/or impacts are expected such as in the automotive industry. A compromise between mechanical strength and electrical connection which must be found when using a single press-in zone is not needed and press-in zones 4 and 5 may be adapted in an optimum manner. Compared to a press-in pin having one press-in zone, the advantageous press-in pin 1 may be manufactured almost cost-neutrally because only the shape of the punch-bending tool must be adapted for producing press-in pin 1.

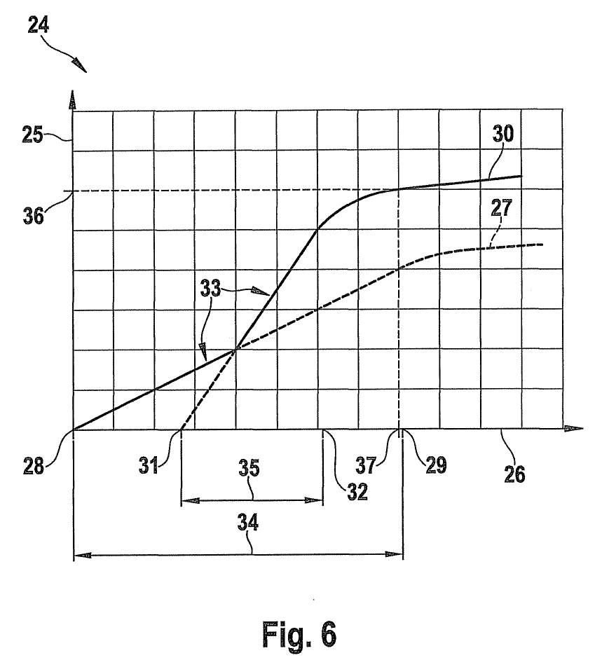

FIG. 6 shows an exemplary folding force-folding path diagram 24, in which folding force 25 is plotted against a folding path 26 of press-in zones 4 and 5. Diagram 24 shows a curve 27, which represents the theoretical variation of the folding force plotted against the folding path of second press-in zone 5. The curve starts at origin 28 of the diagram and runs initially as an idealized straight line which corresponds to Hooke's straight line for press-in zone 5 and increases with increasing folding path 26 to a value 29. Starting at value 29, the slope of curve 27 decreases.

A second curve 30 represents the folding force/folding path curve of first press-in zone 4. Since press-in zone 4 is only deformed by opening 18 after press-in zone 5 and is narrower than press-in zone 5, curve 30 starts at a later value 31 on folding path axis 26 and runs much steeper than curve 27 until a value 32, which is still before value 29 as an idealized (Hooke's) straight line before the slope decreases. The areas between values 28 and 29, as well as 31 and 32, represent the elastic deformation areas of press-in zones 4 and 5, respectively. Solid curve 33 represents the curve of the resulting, idealized folding force of the two press-in zones 4 and 5 plotted against folding path 26. Due to the geometric configuration of the press-in zones, second press-in zone 5 has a larger elastic deformation area 43 than first press-in zone 4 (35). In addition, the folding force needed for deforming press-in zone 5 is lower than that of press-in zone 4, so that metal plating 22 of opening 18 is not damaged during insertion. The nominal resulting folding force of the two press-in zones 4 and 5 corresponds to value 36 for an end hole diameter of opening 18 with value 37.

Press-in zone 5 is deformed to such an extent that its plastic deformation range is not reached, so that press-in zone 5 elastically reverts to its original shape when extracted from opening 18.

1-9. (canceled)

10. A press-in pin for producing an electrical connection to a receptacle receiving a section of the press-in pin, comprising:
an elastic press-in zone which produces the electrical connection;
wherein the press-in zone forms a first press-in zone, which is axially adjoined by a second press-in zone, the first press-in zone and the second press-in zone having different elastic behaviors.

11. The press-in pin of claim 10, wherein the first press-in zone and the second press-in zone have a greater diagonal than the receptacle.

12. The press-in pin of claim 10, wherein the diagonal of the second press-in zone is at least as large as the diagonal of the first press-in zone.

13. The press-in pin of claim 10, wherein the second press-in zone has a larger elastic deformation area than the first press-in zone.

14. The press-in pin of claim 10, wherein the second press-in zone has at least one opening.

15. The press-in pin of claim 10, wherein the first press-in zone is plastically deformed in the receptacle, at least partially.

16. The press-in pin of claim 10, wherein the first press-in zone has at least one depression.

17. The press-in pin of claim 10, wherein the second press-in zone has a larger diagonal than the first press-in zone.

18. The press-in pin of claim 10, wherein the second press-in zone has an essentially drop-shaped design.
